(19) United States
(12) Patent Application Publication
(10) Pub. No.: US 2011/0132029 A1
(43) Pub. Date: Jun. 9, 2011

(54) Isolation of Unit Mounted Drive From Chiller Vibrations

(75) Inventors: Vishnu Sishtla, Manlius, NY (US); Cornelius Holmes, North Syracuse, NY (US)

(73) Assignee: CARRIER CORPORATION, Farmington, CT (US)

(21) Appl. No.: 13/058,690

(22) PCT Filed: Aug. 5, 2009
(86) PCT No.: PCT/US09/52844

§ 371 Date: Feb. 11, 2011

Related U.S. Application Data
(60) Provisional application No. 61/087,900, filed on Aug. 11, 2008.

(51) Int. Cl. F25B 1/00; F16F 15/00

(52) U.S. Cl. 62/498; 248/636

(57) ABSTRACT

A mounting bracket is configured to isolate a drive module of a compression type chiller assembly from vibrations. The mounting bracket includes a bracket plate configured to be attached to a chiller assembly component adjacent to the drive module, a mounting plate transversely attached to the bracket plate and configured to be connected to a rail extending along a bottom side of the drive module, and an isolator pad arranged generally over the mounting plate such that the pad is configured to be interposed between the mounting plate and the rail of the drive module.

### BACKGROUND

The present invention relates to vibration isolation. In particular, the present invention relates to methods of and systems for isolating the drive module of a compression type chiller from vibrations.

The use of compression type water-cooled chillers is the most common method of cooling air in medium or large commercial, industrial and institutional buildings. Compression type water-cooled chillers are usually electrically driven, but may also be driven by a combustion engine or other power source. There are several types of compressors employed in water-cooled chillers. One common compressor is a screw compressor, which uses a rotary type positive displacement mechanism to compress the working fluid, such as a refrigerant. Another type of compressor often used in water-cooled chillers employs a centrifugal compressor to compress the refrigerant.

Water-cooled chillers are required to meet stringent noise level requirements, such as those prescribed by the Occupational Safety and Health Association (OSHA). However, both screw chillers and centrifugal chillers have a tendency to generate significant noise during operation. The primary source of noise generated in these types of chillers is pressure pulsations originating from the compressor, which result in the vibration of adjoining components. In particular, the condenser, which is in direct contact with the compressor, has a tendency to transmit vibrations to the variable frequency drive. The variable frequency drive supplies power to the motor and is mounted on the condenser with brackets. Vibrations are transmitted from the condenser to the variable frequency drive via the brackets, which in turn generates undesirable noise as the drive vibrates on the cantilevered bracket connection to the condenser.

One way to reduce noise generation in water-cooled chillers is to reduce the magnitude of the pressure pulsations within the compressor. However, this approach requires a redesign of the compressor, which is costly and time-consuming.

As a result, there is a need in the art for an efficient and cost-effective way to reduce vibrations from being transmitted from the condenser to the variable frequency drive in order to decrease noise generation.

### SUMMARY

Embodiments of the present invention include a mounting bracket configured to isolate a drive module of a compression type chiller assembly from vibrations. The bracket includes a bracket plate configured to be attached to a chiller assembly component adjacent to the drive module, a mounting plate transversely attached to the bracket plate and configured to be connected to a rail extending along a bottom side of the drive module, and an isolator pad arranged generally over the mounting plate such that the pad is configured to be interposed between the mounting plate and the rail of the drive module.

### BRIEF DESCRIPTION OF THE DRAWINGS

FIG. 1A is a side perspective view of a screw chiller assembly.

FIG. 1B is a bottom perspective view of the screw chiller assembly.

FIG. 2A is a perspective view of a first embodiment of a mounting bracket.

FIG. 2B is a perspective view of the mounting bracket fitted with isolators.

FIG. 3 is a side view of the mounting bracket attached to rails of a variable frequency drive.

FIG. 4A is a perspective view of a second embodiment of a mounting bracket.

FIG. 4B is a perspective view of the mounting bracket fitted with isolators.

FIG. 5 is a side view of the mounting bracket attached to rails of a variable frequency drive.

FIG. 6 is a perspective view of rails of a variable frequency drive mounted on mounting brackets.

### DETAILED DESCRIPTION

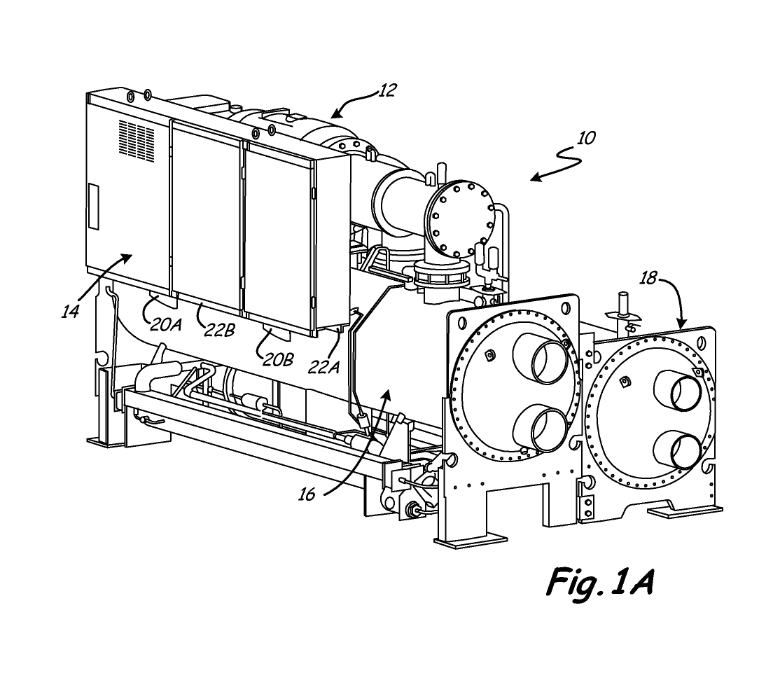

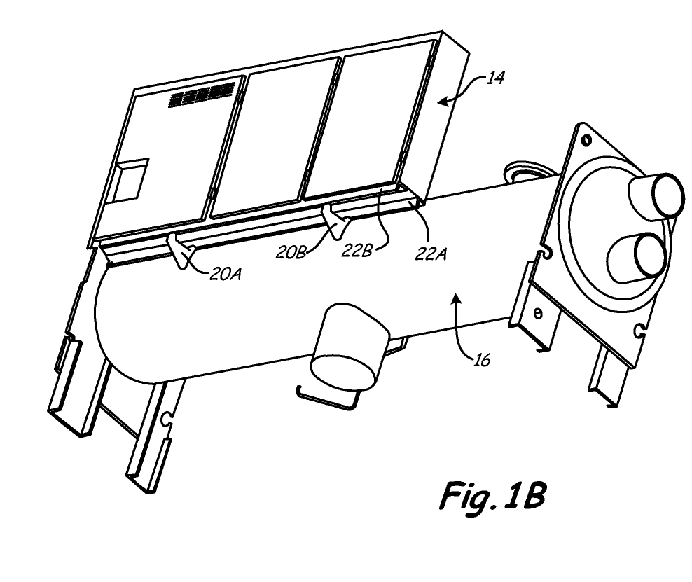

Screw chiller assembly 10 according to the present invention is shown in FIGS. 1A and 1B. FIG. 1A is a side perspective view of screw chiller assembly 10. FIG. 1B is a bottom perspective view of screw chiller assembly 10. Although this disclosure is made with reference to a screw chiller assembly, embodiments of the present invention are appropriate for use with other compression chiller assemblies, such as, for example, a centrifugal chiller assembly. As shown in FIGS. 1A and 1B, screw chiller assembly 10 includes compressor 12, variable frequency drive 14, condenser 16, cooler 18, and mounting brackets 20A, 20B. Variable frequency drive 14 includes rails 22A, 22B, which rails 22A, 22B extend along the bottom of variable frequency drive 14. In the exemplary embodiment shown in FIGS. 1A and 1B, variable frequency drive 14 is mounted on condenser 16 with mounting brackets 20A, 20B. Mounting brackets 20A, 20B are attached to the outside of condenser 16 by any suitable manner, such as by welding. Variable frequency drive 14 is attached to mounting brackets 20A, 20B via rails 22A, 22B. Rails 22A, 22B are generally L-shaped and are positioned parallel to each other along the length of the bottom side of variable frequency drive 14. Rails 22A, 22B may be attached to mounting brackets 20A, 20B in any suitable manner, such as with bolts, screws, rivets, or other suitable fasteners. Compressor 12 and cooler 18 are connected to condenser 16 via steel suction and discharge pipes (not shown).

In operation, gaseous refrigerant is induced into compressor 12 and compressed. Compressor 12 is driven by a motor under the control of variable frequency drive 14. Variable frequency drive 14 controls the frequency of the alternating current (AC) supplied to the motor thereby controlling the speed of the motor and the output of compressor 12. After the refrigerant is compressed, the high temperature, high pressure refrigerant gas is supplied to condenser 16. In condenser 16, the gaseous refrigerant condenses into liquid as it gives up heat. The condensed liquid refrigerant then flows into cooler 18, which circulates chilled water. The low pressure environment in cooler 18 causes the refrigerant to change states to a gas and, as it does so, it absorbs the required heat of vaporization from the chilled water, thus reducing the temperature of the water. The low pressure vapor is then drawn into the inlet of compressor 12 and the cycle is continually repeated. The chilled water is circulated through a distribution system to cooling coils for, for example, comfort air conditioning.

Variable frequency drive 14 is used to control the capacity of screw chiller assembly 10. As the refrigerant circulates through screw chiller assembly 10 at a given speed, dynamic pressure pulsations in the discharge gas are generated. In particular, these types of pressure pulsations originate from compressor 12 and excite structures connected to compressor 12, such as condenser 16, both directly and indirectly. The frequency of gas pressure pulsations is a function of lobes on the compressor male rotor and the speed of the compressor, which varies linearly with drive frequency. The pressure pulsations act as a forcing function, which generates vibrations in chiller assembly 10. These vibrations may be transmitted from condenser 16 to variable frequency drive 14 through mounting brackets 20A-20B. The vibrations are particularly high when the natural frequency of a system component matches the excitation frequency of the gas pressure pulsations. However, even if the excitation frequencies differ from the natural frequency, high vibrations may still exist due to the forced response to the gas pressure pulsations. The vibrations transmitted to variable frequency drive 14 result in the generation of noise, which is undesirable and may violate OSHA requirements. Therefore, embodiments of the present invention include mounting brackets having vibration isolators configured to form an isolation barrier between the mounting brackets and drive module so that the drive module is substantially isolated from vibrations transmitted through the mounting brackets.

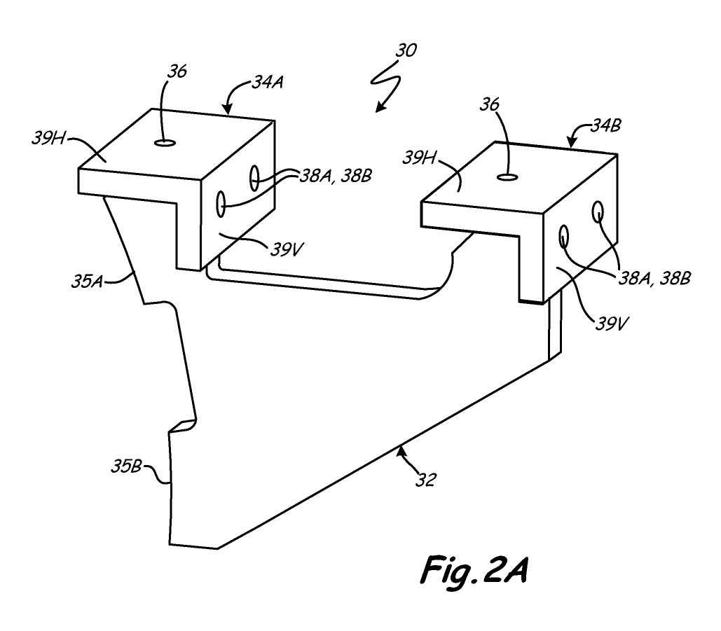

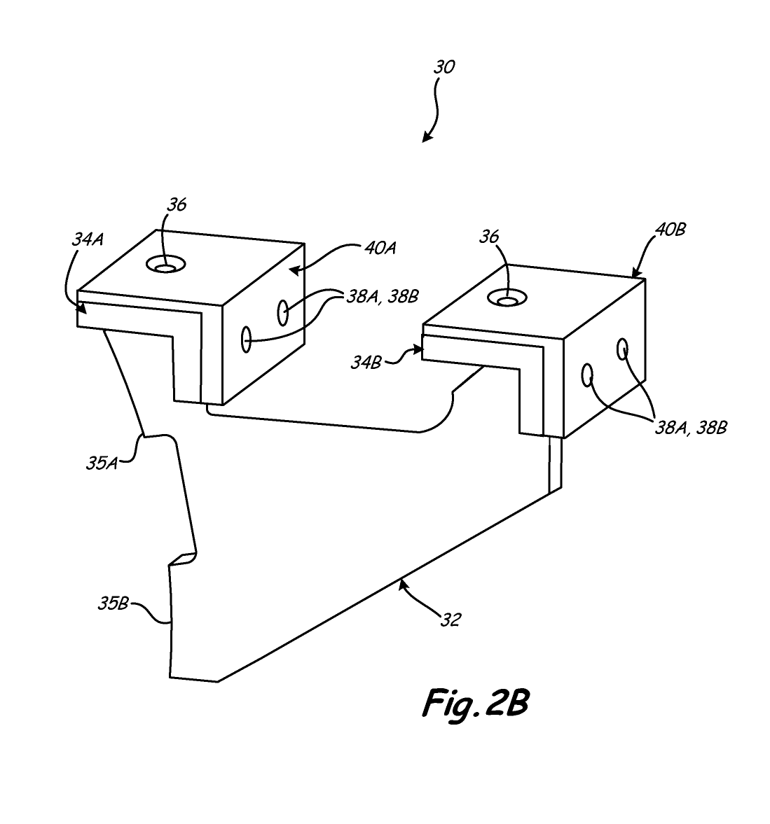

FIG. 2A is a perspective view of mounting bracket 30 according to the present invention, which bracket 30 includes bracket plate 32 and mounting plates 34A, 34B. Bracket plate 32 includes attachment wings 35A, 35B, and each mounting plate 34A, 34B includes hole 36 extending through a horizontal surface 39H and holes 38A, 38B extending through a vertical surface 39V.

In the exemplary embodiment shown in FIG. 2A, bracket plate 32 is configured for attachment to an adjacent component, such as compressor 16 (shown in FIGS. 1A and 1B). Attachment wings 35A, 35B are shaped to fit against a side of condenser 16. Attachment wings 35A, 35B can then be secured to condenser 16 using any suitable method, such as welding.

Mounting bracket 30 includes first and second mounting plates 34A, 34B attached to the top surface of bracket plate 32. Mounting plates 34A, 34B are configured for attachment to rails 22A, 22B of variable frequency drive 14 (shown in FIG. 1B) and may be any size suitable for adequately securing rails 22A, 22B. Mounting plates 34A, 34B are generally L-shaped and, therefore, each mounting plate 34A, 34B includes both horizontal surface 39H and vertical surface 39V. Bolt hole 36 extends through horizontal surface 39H of each mounting plate 34A, 34B and is configured to allow attachment of an isolator (shown in FIG. 2B) to mounting plate 34A, 34B via a fastener. Holes 38A, 38B extend through vertical surface 39V of each mounting plate 34A, 34B and are configured to allow attachment of rails 22A-22B (shown in FIG. 1B) to mounting plate 34A, 34B via first and second fasteners. Although mounting plates 34A, 34B are shown with one hole extending through horizontal surfaces 39H and two holes extending through vertical surfaces 39V, additional holes may be needed depending upon the size of the fasteners and the weight of the variable frequency drive to be mounted.

Mounting bracket 30 may be formed from any suitable material, as long as the material has sufficient strength and durability to secure a drive module, such as variable frequency drive 14. In an exemplary embodiment, mounting bracket 30 is formed entirely of carbon steel.

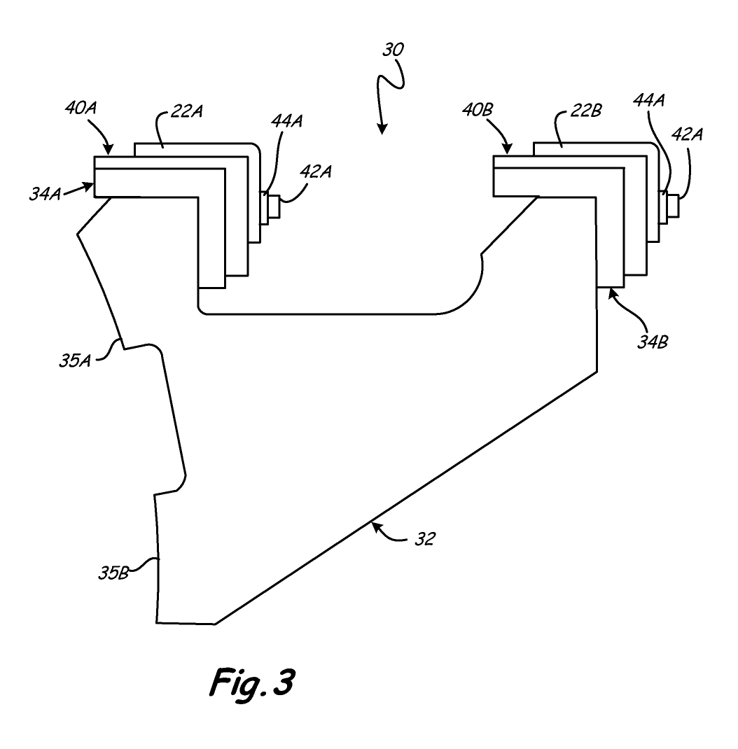

FIG. 2B is a perspective view of mounting bracket 30 (described in detail with reference to FIG. 2A) fitted with isolator pads 40A, 40B. Isolator pads 40A, 40B are generally L-shaped and are configured to fit snuggly over mounting plates 34A, 34B, respectively. In this way, isolator pad 40A completely covers the outer surfaces (vertical and horizontal surfaces 39V, 39H shown in FIG. 2A) of mounting plate 34A and isolator pad 40B completely covers the outer surfaces of mounting plate 34B. Like each mounting plate 34A, 34B, each isolator pad 40A, 40B includes both a horizontal surface and a vertical surface. Hole 36 extends through the horizontal surface of each isolator pad 40A, 40B and continues through horizontal surface 39H (shown in FIG. 2A) of each mounting plate 34A, 34B when isolator pads 40A, 40B and mounting plates 34A, 34B are correctly positioned with the respect to one another. Hole 36 is configured to allow attachment of each isolator pad 40A, 40B to mounting plate 34A, 34B, respectively, via a fastener. Since the horizontal surface of each isolator pad 40A, 40B is flush against a bottom surface of a corresponding rail 22A, 22B when rails 22A, 22B are attached to mounting bracket 30 (shown in FIG. 3) hole 36 may be countersunk at the horizontal surface of each isolator pad 40A, 40B. As a result, when a fastener is inserted through hole 36 through the horizontal surface of each isolator pad 40A, 40B, the fastener is embedded in isolator pad 40A, 40B and does not contact rails 22A, 22B when they are attached to mounting bracket 30. Additionally, holes 38A, 38B extend through the vertical surface of each isolator pad 40A, 40B and continue through vertical surface 39V (shown in FIG. 2A) of each mounting plate 34A, 34B when isolator pads 40A, 40B and mounting plates 34A, 34B are correctly positioned with respect to one another. Holes 38A, 38B are configured to allow attachment of rails 22A-22B to mounting plate 34A, 34B via first and second fasteners.

Isolator pads 40A, 40B may be formed of any suitable material, which is capable of absorbing vibrations. In an exemplary embodiment, isolator pads 40A, 40B are comprised of Fabcell®, which is an elastomeric material manufactured by Fabreeka International, Inc. of Boston, Mass. Isolator pads 40A, 40B must be thick enough to provide adequate vibration isolation, yet thin enough to allow the variable frequency drive to be supported by mounting bracket 30. In an exemplary embodiment, isolator pads 40A, 40B are about 25 millimeters to about 75 millimeters thick. Isolator pads 40A, 40B are capable of reducing vibrations having a frequency of about 20 Hz by about 60 percent, vibrations having a frequency of about 40 Hz by about 90 percent, and vibrations having a frequency of about 90 Hz by about 98 percent.

FIG. 3 is a side view of mounting bracket 30 attached to rails 22A, 22B with bolts 42A, 42B. Also shown are isolator washers 44A, 44B. In the exemplary embodiment shown in FIG. 3, isolator pads 40A, 40B have been attached to mounting plates 34A, 34B, respectively (described in detail with reference to FIG. 2B). Rails 22A, 22B, which are generally L-shaped and extend along a bottom surface of variable frequency drive 14 shown in FIGS. 1A and 1B, are positioned such that rail 22A fits over isolator pad 40A and rail 22B fits over isolator pad 40B. Each rail 22A, 22B includes first and second holes (not shown) extending through its vertical surface. These holes are aligned with holes 38A, 38B, which extend through the vertical surface of each isolator pad 40A, 40B and vertical surface 39V of each mounting plate 34A, 34B. When the rails are correctly positioned, first and second bolts 42A, 42B are inserted through rail 22A, isolator pad 40A and mounting plate 34A and first and second bolts 42A, 42B are inserted through rail 22B, isolator 40B and mounting plate 34B. (Only bolts 42A are visible from the perspective shown in FIG. 3.) Isolator pads 40A, 40B form an isolation barrier between mounting plates 34A, 34B and rails 22A, 22B so that variable frequency drive 14 (attached to rails 22A, 22B) is protected from vibrations transmitted through mounting bracket 30.

When inserted, the heads of bolts 42A, 42B are in direct contact with the outer surface of rails 22A, 22B. As a result, it may be possible for vibrations to be transmitted through bolts 42A, 42B to variable frequency drive 14 through rails 22A, 22B. Therefore, bolts 42A, 42B may be fitted with doughnut shaped isolator washers 44A, 44B. (Only isolator washers 44A are visible from the side shown in FIG. 3.) Isolator washers 44A, 44B may be comprised of the same type of material as isolator pads 40A, 40B (described with reference to FIG. 2B) and are sized to receive bolts 42A, 42B. Isolator washers 44A, 44B are configured such that when bolts 42A, 42B are inserted into rails 22A, 22B, isolator washers 44A, 44B form an isolation barrier between bolts 42A, 42B and rails 22A, 22B.

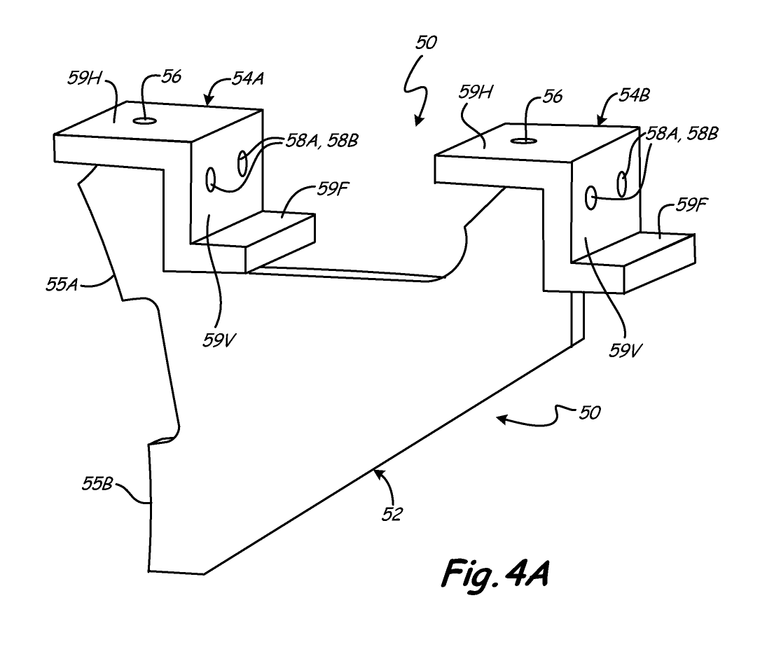

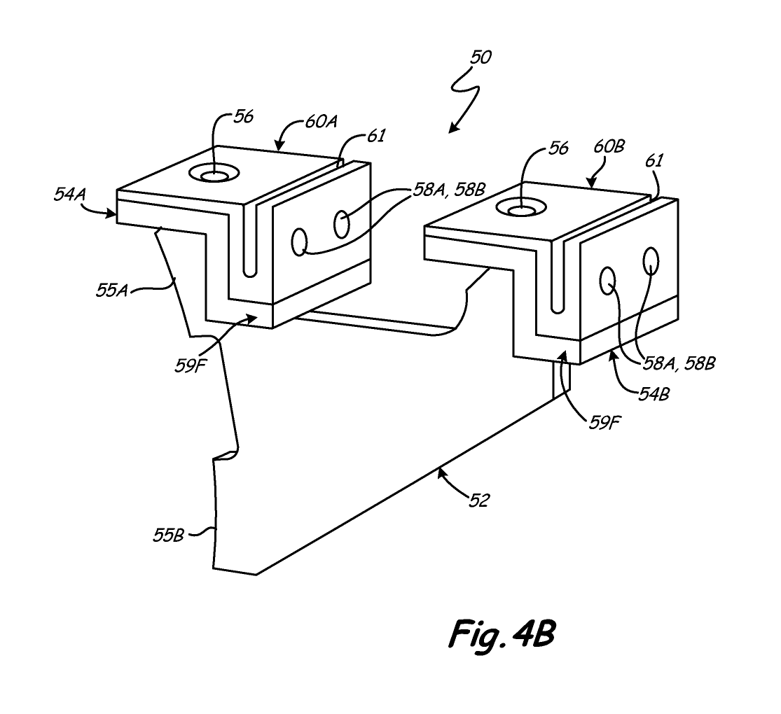

Another embodiment of the present invention is shown in FIGS. 4A and 4B. FIG. 4A is a perspective view of mounting bracket 50, which comprises bracket plate 52 and mounting plates 54A, 54B. Bracket plate 52 includes attachment wings 55A, 55B, and each mounting plate 54A, 54B includes hole 56 extending through horizontal surface 59H and holes 58A, 58B extending through vertical surface 59V. In addition, each mounting plate 54A, 54B includes flange 59F.

In the exemplary embodiment shown in FIG. 4A, bracket plate 52 is configured for attachment to an adjacent component, such as condenser 16 (shown in FIGS. 1A and 1B). Attachment wings 55A, 55B are shaped to fit against a side of condenser 16. Attachment wings 55A, 55B can then be secured to condenser 16 using any suitable method, such as welding.

Mounting bracket 50 includes first and second mounting plates 54A, 54B attached to a top surface of bracket plate 52. Mounting plates 54A, 54B are configured for attachment to rails 22A, 22B of condenser 16 (shown in FIG. 1B) and may be any size suitable for adequately securing rails 22A, 22B. Mounting plates 54A, 54B are generally Z-shaped and, therefore, each mounting plate 54A, 54B includes horizontal surface 59H, vertical surface 59V, and flange 59F. Hole 56 extends through horizontal surface 59H of each mounting plate 54A, 54B and is configured to allow attachment of an isolator pad (shown in FIG. 4B) to mounting plate 54A, 54B via a fastener. Holes 58A, 58B extend through vertical surface 59V of each mounting plate 54A, 54B and are configured to allow attachment of rails 22A-22B (shown in FIG. 1B) to mounting plate 54A, 54B via first and second fasteners. Although mounting plates 54A, 54B are shown with one hole extending through horizontal surfaces 59H and two holes extending through vertical surfaces 59V, more holes may be needed depending upon the size of the fasteners and the weight of the variable frequency drive to be mounted. Flange 59F extends outward from vertical surface 59V of each mounting plate 54A, 54B and provides extra support for rails 22A, 22B.

FIG. 4B is a perspective view of mounting bracket 50 (described in detail with reference to FIG. 4A) fitted with isolator pads 60A, 60B. Isolator pads 60A, 60B are generally L-shaped with slot 61 formed in a leg abutting flanges 59F of mounting plates 54A, 54B. Isolator pads 60A, 60B are configured to fit snuggly against the outer surfaces of mounting plate 54A, 54B, respectively. In this way, isolator pad 60A completely covers the outer surfaces of mounting plate 54A and isolator pad 60B completely covers the outer surfaces of mounting plate 54B. Like each mounting plate 54A, 54B, each isolator pad 60A, 60B includes both a horizontal surface and a vertical surface. Hole 56 extends through the horizontal surface of each isolator pad 60A, 60B and continues through horizontal surface 59H (shown in FIG. 4A) of each mounting plate 54A, 54B when isolator pads 60A, 60B and mounting plates 54A, 54B are correctly positioned with the respect to one another. Hole 56 is configured to allow attachment of each isolator pad 60A, 60B to mounting plate 54A, 54B, respectively, via a fastener. Since a horizontal surface of each isolator pad 60A, 60B is flush against a bottom surface of a corresponding rail 22A, 22B when rails 22A, 22B are attached to mounting bracket 50 (shown in FIG. 3) hole 56 may be countersunk at the horizontal surface of each isolator pad 60A, 60B. As a result, when a fastener is inserted through hole 56 through the horizontal surface of each isolator pad 50A, 50B, the fastener is embedded in isolator 60A, 60B so it does not contact rails 22A, 22B when they are attached to mounting bracket 50. Additionally, holes 58A, 58B extend through the vertical surface of each isolator pad 60A, 60B and continue through vertical surface 59V (shown in FIG. 4A) of each mounting plate 54A, 54B when isolator pads 60A, 60B and mounting plates 54A, 54B are correctly positioned with respect to one another. Holes 58A, 58B are configured to allow attachment of rails 22A-22B to mounting plate 54A, 54B via first and second fasteners.

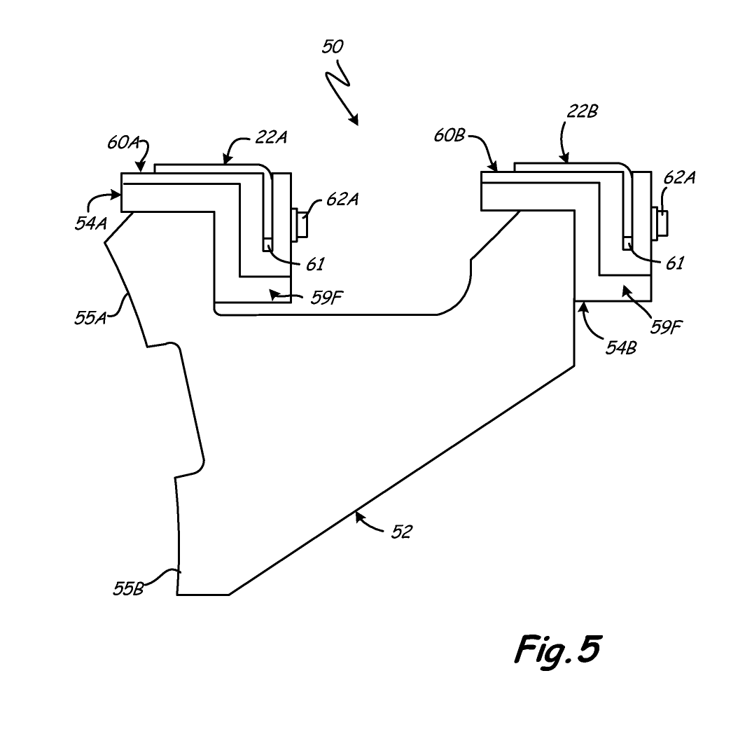

Isolator pads 60A, 60B also each include slot 61, which extends from the horizontal surface of each isolator pad 60A, 60B into the portion of isolator 60A, 60B abutting flange 59F. Slot 61 is configured to receive rail 22A, 22B, such that one leg of each rail 22A, 22B is enveloped within isolator pad 60A, 60B, respectively, when rails 22A, 22B are attached to mounting bracket 50 (shown in FIG. 5). Isolator pads 60A, 60B may be comprised of the same type of material as isolator pads 40A, 40B (described with reference to FIG. 2B).

FIG. 5 is a side view of mounting bracket 50 attached to rails 22A, 22B with bolts 62A, 62B. In the exemplary embodiment shown in FIG. 5, isolator pads 60A, 60B have been attached to mounting plates 54A, 54B, respectively (described in detail with reference to FIG. 4B). Rails 22A, 22B, which are generally L-shaped and extend along a bottom surface of variable frequency drive 14, are positioned such that rail 22A fits over isolator pad 60A and rail 22B fits over isolator pad 60B. Each rail 22A, 22B includes first and second holes (not shown) extending through its vertical surface. These holes are aligned with holes 58A, 58B, which extend through the vertical surface of each isolator pad 60A, 60B and vertical surface 59V of each mounting plate 54A, 54B. When the rails 22A, 22B are correctly positioned within slot 61, first and second bolts 62A, 62B are inserted through rail 22A, isolator pad 60A and mounting plate 54A and first and second bolts 62A, 62B are inserted through rail 22B, isolator pad 60B and mounting plate 54B. (Only bolts 62A are visible from the side shown in FIG. 5.) Isolator pads 60A, 60B form an isolation barrier between mounting plates 54A, 54B and rails 22A, 22B and bolts 62A, 62B, so that variable frequency drive 14 (attached to rails 22A, 22B) is protected from vibrations transmitted through mounting bracket 50.

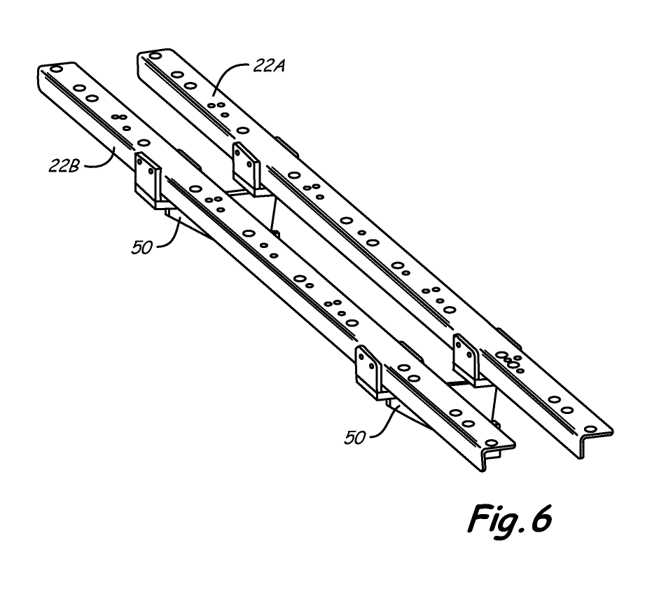

FIG. 6 is a perspective view of rails 22A, 22B mounted on mounting brackets 50. In the exemplary embodiment shown in FIG. 6, rails 22A, 22B are mounted on two mounting brackets 50. However, the invention is not so limited, and more mounting brackets 50 may be needed depending upon the size and weight of the variable frequency drive to be mounted. In addition, although rails 22A, 22B are shown mounted on mounting brackets 50, rails 22A, 22B may be similarly mounted on mounting brackets 30 of FIGS. 2A-3.

Compression type chiller assemblies according to the present invention have several advantages over prior chillers. Embodiments of the present invention include mounting brackets having vibration isolators configured to form an isolation barrier between the mounting brackets and drive module so that the drive module is substantially isolated from vibrations transmitted through the mounting brackets. The isolators may be in the form of pads interposed between the mounting brackets and the drive module to which the brackets are attached. Additionally, mounting brackets according to the present invention may include isolator washers configured to isolate the bolted connection between the drive module and the bracket. Isolating the drive module from the other components of the chiller assembly acts to prevent vibrations from propagating through the assembly to the drive module, which in turn significantly reduces noise generated from drive module vibration. Reducing noise generation improves the operating environment of the chiller and may ensure compliance with industry standards, such as OSHA.

Although the present invention has been described with reference to preferred embodiments, workers skilled in the art will recognize that changes may be made in form and detail without departing from the spirit and scope of the invention.

1. A mounting bracket configured to isolate a drive module of a compression type chiller assembly from vibrations, the bracket comprising:
a bracket plate configured to be attached to a chiller assembly component adjacent to the drive module;
a mounting plate attached to the bracket plate and configured to be connected to a rail extending along a bottom side of the drive module; and
an isolator pad arranged generally over the mounting plate such that the pad is configured to be interposed between the mounting plate and the rail of the drive module.

2. The mounting bracket of claim 1, wherein the isolator pad is configured to form an isolation barrier between the mounting plate and the rail so that the drive module is substantially isolated from vibrations transmitted through the mounting plate.

3. The mounting bracket of claim 1, wherein the mounting plate, the rail, and the isolator pad are each L-shaped and are arranged such that the isolator pad receives the mounting plate and the rail receives the isolator pad and the mounting plate.

4. The mounting bracket of claim 1,
wherein the mounting plate is Z-shaped;
wherein the isolator pad is L-shaped with a first leg and a second leg including a slot configured to receive the rail; and
wherein the first isolator pad leg is arranged over a first leg of the mounting plate, the second isolator pad leg is arranged over a second leg of the mounting plate, and a third leg of the mounting plate abuts an end of the second isolator pad leg opposite an end of the second isolator pad leg including the slot formed therein.

5. The mounting bracket of claim 4,
wherein the rail is L-shaped; and
wherein one leg of the rail is arranged over the first leg of the isolator pad and the other leg of the rail is received in the slot of the second leg of the isolator pad.

6. The mounting bracket of claim 1, wherein the isolator pad and the mounting plate have aligned holes configured to allow connection of the isolator to the mounting plate by a fastener which extends through the holes.

7. The mounting bracket of claim 1, wherein the isolator pad and the mounting plate have aligned holes configured to allow the drive module to be mounted to the mounting bracket by a fastener which extends through the holes and through a hole in the rail of the drive module.

8. The mounting bracket of claim 7 further comprising:
an isolator washer configured to receive the fastener such that an isolation barrier is formed between the fastener and the rail when the drive module is mounted on the mounting bracket so that the drive module is substantially isolated from vibrations transmitted through the fastener.

9. The mounting bracket of claim 1 wherein the isolator pad is capable of reducing transmission of vibrations to the drive module having a frequency greater than or equal to about 20 Hz.

10. The mounting bracket of claim 1 further comprising:
a second mounting plate attached to the bracket plate and configured to be connected to a second rail extending along the bottom side of the drive module; and
a second isolator pad arranged generally over the second mounting plate such that the second pad is configured to be interposed between the second mounting plate and the second rail of the drive module.

11. The mounting bracket of claim 10 wherein the mounting bracket is capable of reducing transmission of vibrations to the drive module having a frequency of about 20 Hz by about 60 percent.

12. The mounting bracket of claim 10 wherein the mounting bracket is capable of reducing transmission of vibrations to the drive module having a frequency of about 40 Hz by about 90 percent.

13. The mounting bracket of claim 10 wherein the mounting bracket is capable of reducing transmission of vibrations to the drive module having a frequency of about 90 Hz by about 98 percent.

14. The mounting bracket of claim 1 wherein the isolator pad has a thickness of about 25 millimeters to about 75 millimeters.

15. A compression type chiller assembly comprising:
a condenser;
a drive module;
a rail extending along a bottom side of the drive module; and
a mounting bracket connecting the drive module to the condenser, wherein the mounting bracket comprises:
a bracket plate attached to the condenser;
a mounting plate attached to the bracket plate and connected to the rail; and
an isolator pad arranged generally over the mounting plate such that the pad is interposed between the mounting plate and the rail.

16. The chiller assembly of claim 15, wherein the isolator pad is configured to form an isolation barrier between the mounting plate and the rail so that the drive module is substantially isolated from vibrations transmitted through the mounting plate.

17. The chiller assembly of claim 15, wherein the mounting plate, the rail, and the isolator pad are each L-shaped and are arranged such that the isolator pad receives the mounting plate and the rail receives the isolator pad and the mounting plate.

18. The chiller assembly of claim 15,
wherein the mounting plate is Z-shaped;
wherein the isolator pad is L-shaped with a first leg and a second leg including a slot configured to receive the rail; and
wherein the first isolator pad leg is arranged over a first leg of the mounting plate, the second isolator pad leg is arranged over a second leg of the mounting plate, and a third leg of the mounting plate abuts an end of the second isolator pad leg opposite an end of the second isolator pad leg including the slot formed therein.

19. The chiller assembly of claim 18,
wherein the rail is L-shaped; and
wherein one leg of the rail is arranged over the first leg of the isolator pad and the other leg of the rail is received in the slot of the second leg of the isolator pad.

20. The chiller assembly of claim 15, wherein the isolator pad and the mounting plate have aligned holes configured to allow connection of the isolator to the mounting plate by a fastener which extends through the holes.

21. The chiller assembly of claim 15, wherein the isolator pad and the mounting plate have aligned holes configured to allow the drive module to be mounted to the mounting bracket by a fastener which extends through the holes and through a hole in the rail of the drive module.

22. The chiller assembly of claim 21 further comprising:
an isolator washer configured to receive the fastener such that an isolation barrier is formed between the fastener and the rail when the drive module is mounted on the mounting bracket so that the drive module is substantially isolated from vibrations transmitted through the fastener.

23. The chiller assembly of claim 15 wherein the isolator pad is capable of reducing transmission of vibrations to the drive module having a frequency greater than or equal to about 20 Hz.

24. The chiller assembly of claim 15 wherein the isolator pad has a thickness of about 25 millimeters to about 75 millimeters.

25. The chiller assembly of claim 15,
wherein drive module further comprises a second rail extending along the bottom side of the drive module;
wherein the mounting bracket further comprises:
a second mounting plate attached to the bracket plate and connected to the second rail; and
a second isolator pad arranged generally over the second mounting plate such that the second pad is interposed between the second mounting plate and the second rail of the drive module.
